(19) United States
(12) Patent Application Publication
(10) Pub. No.: US 2006/0210756 A1
(43) Pub. Date: Sep. 21, 2006

(54) Audio video disc protector

(76) Inventors: Randall B. Harmon, Dallas, GA (US); James D. Harmon, Dallas, GA (US)

Correspondence Address: RANDALL B. HARMON, 99 MT. TABOR CT., DALLAS, GA, 30157, US

(21) Appl. No.: 10/876,096

(22) Filed: Mar. 16, 2004

(51) Int. Cl. B32B 3/02

(52) U.S. Cl. 428/64.1; 428/66.6

(57) ABSTRACT

The CD Cling is a thin flexible and printable polymer used to protect audio, video and data optical storage disc by using static cling to adhere to the data side of the disc without leaving any residue or damaging the disc in any way. The protector also creates a new avenue for advertising and marketing by allowing clients to print logos and other marketing graphics on the side not being adhered to the optical storage disc. The protector also has a tab built into the design of the protector for removing and applying said protector. The size of the polymer protector will be the same diameter of the optical disc it is protecting which in return will require no additional storage space.

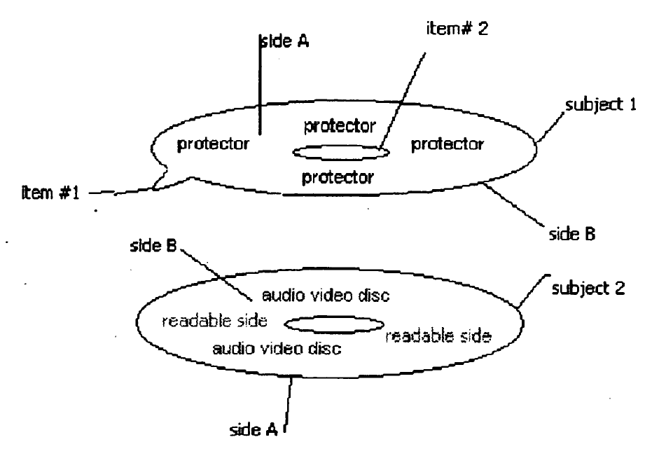

### BACKGROUND OF THE INVENTION

The audio, video, and computer optical data disc are very fragile disc that are easily damaged through everyday use and handling. The discs are usually delivered to consumers in a case that is often lost, damaged, or thrown away. This allows the disc to be even more acceptable to damages. When the disc becomes damaged it has to be repaired or replaced. Both are very costly. There are several different methods of protecting the disc that consists of buying storage units that are very bulky and space consuming. There are also different types of disc repairing items that use a chemical substance that is applied to the disc that can affect the quality of the disc's performance. Most consumers object to these methods of protecting because of the cost and performance issues.

Static cling vinyl is a formulation of polyvinyl chloride with a large amount of plasticizer (liquid) added. This is then calendared to give a smooth finish. When applied to a smooth and glossy surface it attaches to that surface with a static cling. Since there is no chemical adhesive applied, it leaves no residue when removed.

We claim:

1) That the Audio Video Disc Protector protects the data side of any optical data storage disc with a thin layer of static cling polymer film.

2) That while adhering to data disc, no damage will be done to the disc due to chemicals or any other adhesives.

3) That the side of the protector that is not being applied to the optical disc will be used for advertising, marketing graphics, and labeling.

4) That the Audio Video Disc protector's size will be determined by the size of the disc it is protecting.

5) That the Audio Video Disc protector will have ultraviolet protection impregnated into said polymer film.

6) That the Audio Video Disc protector will vary in thickness from 0.0001″ to 0.009″ due to different manufacturer specifications and customer request.

7) That the Audio Video Disc protector will have a tab built in to the design for easy application and removal of said protector.

8) The tab will be approx: 0.25″ to 0.5″ depending on customer request.

9) That the Audio Video Disc protector will also be used to protect the label side of the optical disc using the same method as listed above.

10) The names of the type of optical discs the protector will most commonly be used to protect are DVD's, Compact Disc and CD Roms.

11) The Audio Video Disc protector will also create a new and exciting avenue for media marketing and advertising never used before now.

12) The Audio Video Disc protector will never wear out therefore reducing cost to consumer and manufacturer.

13) The Audio Video Disc protector, while protecting the disc from scratches, dings, and any other blemishes will take up no more storage space than the disc it is protecting. The protector will also fit in any already used storage unit for additional protection.

14) The Audio Video Disc protector will protect disc from finger prints, scratches and dust due to excessive use and handling.
